(19) United States
(12) Patent Application Publication
(10) Pub. No.: US 2011/0307564 A1
(43) Pub. Date: Dec. 15, 2011

(54) DATA NODE APPARATUS, PEER INFORMATION ACQUISITION METHOD AND SYSTEM

(75) Inventors: Yanlin Luo, Beijing (CN); Yongqiang Liu, Beijing (CN); Songjie Chen, Beijing (CN); Quan Huang, Beijing (CN)

(73) Assignee: NEC (CHINA) CO., LTD., Beijing (CN)

(21) Appl. No.: 13/124,770

(22) PCT Filed: Mar. 19, 2010
(86) PCT No.: PCT/CN10/00335

§ 371 Date: Apr. 18, 2011

(30) Foreign Application Priority Data
Apr. 1, 2009 (CN) 200910132675.0

(51) Int. Cl. G06F 15/16

(52) U.S. Cl. 709/206; 709/204

(57) ABSTRACT

A data node apparatus, a peer information acquisition method and a system are provided. An apparatus that serves as a data node in peer-to-peer (P2P) data exchange, comprising: a data node application unit that issues a peer list request and carries out data exchange with peers; and a list processing unit that intercepts an original peer list provided by an indexing server in response to the peer list request, issues a peer location request to an information server and receives peer location information provided by the information server in response to the peer location request, performs a processing on the original peer list based on the peer location information to derive a processed peer list, and provides the processed peer list to the data node application unit.

### FIELD OF THE INVENTION

The invention generally relates to computer networks, and in particular to a data node apparatus, a peer information acquisition method and a system for providing and acquiring peer information used in peer-to-peer (P2P) data exchange that can reduce P2P cross-domain traffic.

### BACKGROUND

P2P system is a distributed data sharing system, which may provide services such as file sharing, streaming media, Voice over Internet Protocol (VoIP) and the like. The amount of traffic in a P2P system is tremendous. It is reported that P2P traffic accounts for 70% of Internet traffic all over the world. Most of the exiting P2P implementations have not taken the topology condition of the network into account. Peering decision is made independently of network topology and traffic condition. In response to a request made by a querying data node application unit, an indexing server will typically select a subset from an existing metadata set in random. Such a random answer tends to result in a significant problem of cross-domain traffic.

For example, FIG. 1 shows a block diagram of a system 5 for providing and acquiring peer information according to the prior art. As shown in the figure, when a data node application unit 61 in a data node 60 wants to exchange a data file with peers (not shown) in a P2P system to which it belongs, a peer information requesting unit 612 thereof issues a peer list request to an indexing server 50 in that P2P system. Upon receipt of the peer list request, a peer information management unit 52 in the indexing server 50 searches a peer information storage unit 51 for all the peers that can exchange the data file with the data node application unit 61, and randomly selects a number of peers from among these peers to include them in a peer list, which is returned to the data node application unit 61 as response. Upon receipt of the peer list response, the peer information requesting unit 612 in the data node application unit 61 provides it to the data exchange unit 611. The data exchange unit 611 then exchange data with the peers listed in the peer list.

Because the peers in the peer list returned by the indexing server 50 are randomly selected, they may include data node application units on data nodes located in a different network domain, for example, data node application units on data nodes belonging to a different ISP (Internet Service Provider). Thus, a data node in a network domain will download a data file from a data node in another network domain, even if a data node in the self network domain also has that data file, which results in a huge amount of cross-domain traffic.

To reduce the huge amount of cross-domain traffic produced by a P2P system, ISP has once enforced a blocking policy on P2P applications, which, however, has not achieved a great effect. Presently, some scholars have also proposed a solution in which existing system code is modified. For example, Haiyong Xie, Y. Richard Yang, Arvind Krishnamurthy, Yanbin Liu and Avi Silberschatz, “P4P: Provider Portal for Applications”, SIGCOMM'2008, pp. 351-362 (Document 1) introduces a new P2P network architecture: P4P (Proactive network Provider Participation for P2P). This architecture allows a network provider to provide more information to an application and can reduce unnecessary cross-ISP traffic. As an interface between the network and the application, P4P may provide a querying client with a lot of information such as static network policy, P4P distance reflecting condition of the network, network capability, and the like. The core of this new architecture is a P4P distance interface through which the ISP can provide application overhead information on current internal links and external links to the application. The P4P architecture introduces an information server as an interface for communication between the network operator and the application.

For example, FIG. 2 shows a block diagram of another system 5a for providing and acquiring peer information according to the prior art described in Document 1. The system 5a is different from the system 5 shown in FIG. 1 in that it further includes an information server 70. The information server 70 provides network information, including distance, delay, traffic condition, etc. Other entities (the indexing server, and data nodes) in the network may query information regarding distance, network traffic and the like between two nodes through the service interface it provides.

The indexing server 50a shown in the figure is different from the indexing server 50 shown in FIG. 1 in that it further includes a location information requesting unit 53 in addition to the peer information storage unit 51 and a peer information management unit 52a. Thus, like the peer information management unit 52, the peer information management unit 52a in the indexing server 50a, upon receipt of a peer list request, will first search the peer information storage unit 51 for all the peers that can exchange the data with the data node application unit 61. Then, unlike the peer information management unit 52, rather than randomly selecting a number of peers from these peers, the peer information management unit 52a will instruct the location information requesting unit 53 to request from the information server 70 information regarding locations (P4P distances) of all the data nodes on which these peers reside relative to the data node 60, select peers that reside on data nodes close to the data node 60 from the peers that can exchange data with the data node application unit 61 based on the location information received by the location information requesting unit 53 from the information server, and include these adjacent peers in the peer list as a response returned to the data node 60.

Thus, using the information from the information server, the indexing server may reply the client with a peer list including peers most of which come from the same domain (for example, the same ISP).

As can be seen, Document 1 defines a new P2P network architecture for transferring network information and managing cross-domain traffic. However, such a solution can hardly work for current networks. This is because that, first, currently many P2P systems have already been deployed and are producing tremendous network traffic; and second, modification of the code of the indexing server in an existing P2P system is required in order to reduce the cross-domain traffic in the current P2P system, which, however, is difficult to implement.

### SUMMARY OF THE INVENTION

The invention provides a data node apparatus, a peer information acquisition method used thereby, and an associated system, which are used in P2P data exchange and can reduce cross-domain traffic.

According to an aspect of the invention, there is provided an apparatus that serves as a data node in peer-to-peer (P2P) data exchange, comprising: a data node application unit that issues a peer list request and carries out data exchange with peers; and a list processing unit that intercepts an original peer list provided by an indexing server in response to the peer list request, issues a peer location request to an information server and receives peer location information provided by the information server in response to the peer location request, performs a processing on the original peer list based on the peer location information to derive a processed peer list, and provides the processed peer list to the data node application unit.

According to another aspect of the invention, there is provided a method of acquiring peer information at a data node for peer-to-peer (P2P) data exchange, comprising the steps of: issuing a peer list request to an indexing server; intercepting an original peer list provided by the indexing server in response to the peer list request; issuing a peer location request to an information server; receiving peer location information provided by the information server in response to the peer location request; performing a processing on the original peer list based on the peer location information to derive a processed peer list; and providing the processed peer list to a data node application unit.

According to another aspect of the invention, there is provided a system for providing and acquiring peer information in peer-to-peer (P2P) data exchange, comprising: one or more indexing servers, each of which provides an original peer list in response to a peer list request; an information server that provides peer location information in response to a peer location request; and the apparatus as described above.

According to the invention, existing P2P cross-domain traffic can be reduced without modifying existing indexing servers and data node application units, and messages associated with multiple different P2P systems can be processed at the same time by simply deploying one list processing unit in the data node. In addition, short download time can be ensured by re-requesting a peer list.

### DESCRIPTION OF THE DRAWINGS

The above and other features and advantages of the invention can be better understood by reading the detailed description below in connection with the accompanying drawings. In the accompanying drawings, same or similar reference signs are used to designate same or similar elements, in which:

FIG. 1 shows a block diagram of a system according to the prior art.

FIG. 2 shows a block diagram of another system according to the prior art.

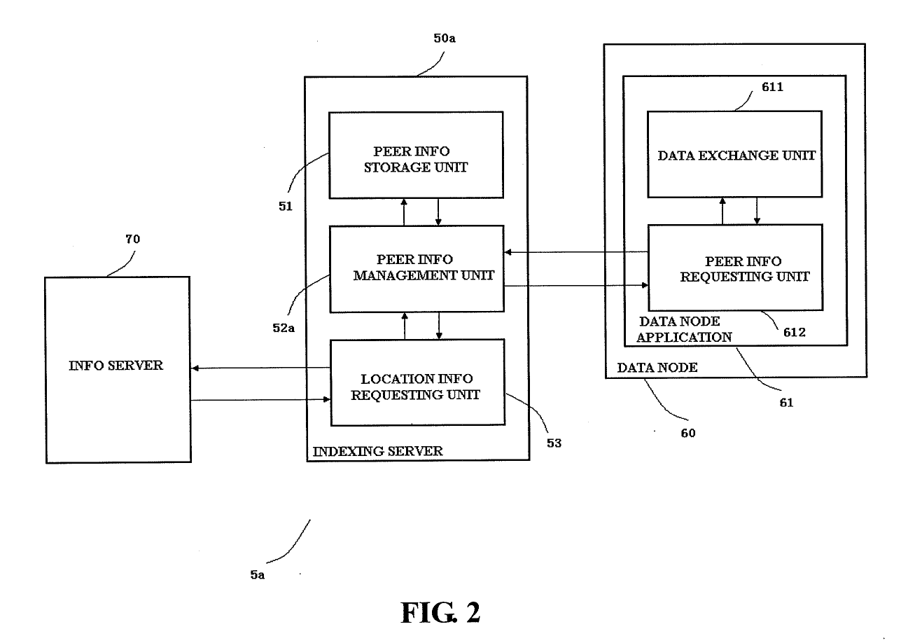

FIG. 3 shows a block diagram of a system including an apparatus serving as data node according to a first embodiment of the invention.

FIG. 4 shows a flowchart of the method for acquiring a peer list by the data node shown in FIG. 3.

FIG. 5 shows a block diagram of a system including an apparatus serving as data node according to a second embodiment of the invention.

FIG. 6 shows a flowchart of the method for acquiring a peer list by the data node shown in FIG. 5.

### DETAILED DESCRIPTION

Before describing the embodiments of the invention with reference to the accompanying drawings, some terms used herein will be explained.

P2P System: a P2P system may include an indexing server, an information server, and a plurality of data node application units that carry out data exchange and are peers to each other.

Indexing Server: an entity that stores metadata of all the files being exchanged and information regarding the data nodes on which the data node applications exchanging these files reside. It is also known as Signaling Node, Tracker, appTracker or Super Node. Upon receipt of a peer list request, it replies with a corresponding peer list response. Each P2P system may include one or more indexing servers. Different P2P systems typically have their own indexing server(s).

Information Server: also known as iTracker. It is an entity that provides network information including distance, delay, traffic condition, and the like. Other entities (indexing servers, and data nodes) in the network may query information on distance, network traffic and the like between two data nodes through a service interface it provides. One information server may be shared by a plurality of P2P systems. For example, the information server may be provided by an ISP.

Data Node: an entity that stores the whole or part of an actual data item. A data node may be an information processing apparatus, for example, a personal computer (PCs), a mobile phone, a personal digital assistance (PDA), and the like, which is capable of storing data and communicating with other network nodes over a network.

A data node may host one or more data node application units that belong to one or more P2P systems respectively. For example, a BitTorrent application unit, an eMule application unit, and the like may be installed on a PC. Hereinafter, data node may sometimes be referred to as data node apparatus or apparatus serving as data node.

Data node application unit: a unit for data exchange and peer information query in a P2P system. It includes a data exchange unit and a peer information requesting unit. The peer information requesting unit requests information on peers that are exchanging (downloading/uploading) the desired file from an indexing server in the P2P system to which the data node application unit belongs. The data exchange unit establishes connections with peers in the peer list and carries out downloading/uploading of file data with these peers. The data node application unit may also be referred to as data node application. In addition, in interaction with the indexing server and the information server, the data node application unit may also be referred to as client application unit or client application.

Peer: data node application units in a P2P system are peers to each other. In addition, it may also be said herein that data nodes on which these peering data node application units reside are peers to each other.

Metadata: information that describes attributes of actual data, for example, the location and size of the actual data item.

Network Domain: it generally is a set of network nodes that are in the same area in terms of network topology. For example, the same “network domain” may refer to the same ISP, the same local area network, and the like. If two data nodes belong to the same network domain, it may be said that the respective data node application units hosted by these two data nodes belong to the same network domain.

Location: the “location” herein may not necessarily refer to physical location. Rather, the “location” herein refers to a location of a data node in terms of network topology. In the present invention, locations of peers of a data node application unit with respect to the data node application unit is equivalent to locations of data nodes hosting these peers with respect to the data node hosting the data node application unit. In an example, the relative locations of data nodes may be expressed by network distances therebetween.

Network Distance: it reflects distances between data nodes in terms of network topology. It may be P4P-distances as described above that reflect the network's status and preferences regarding traffic. Similarly, in the present invention, distances between peers of a data node application unit and the data node application unit is equivalent to distances between data nodes hosting these peers and the data node hosting the data node application unit.

The exemplary embodiments of the invention will be described in detailed below with reference to the drawings.

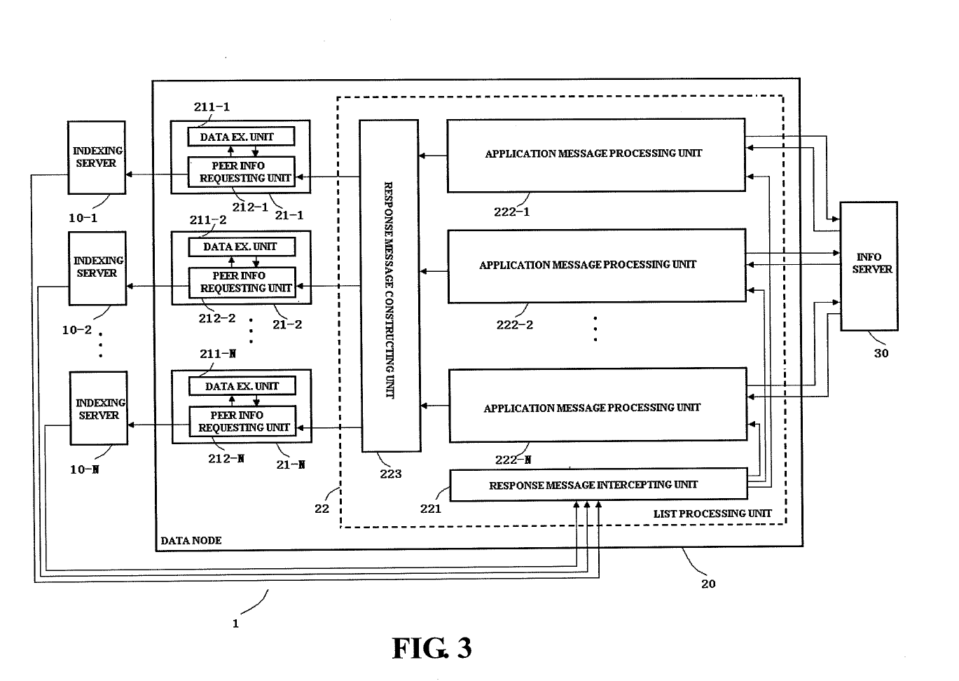

FIG. 3 shows a block diagram of a system 1 constituted of an apparatus 20 serving as data node (referred to as data node 20 hereinafter) according to a first embodiment of the invention and one or more indexing servers 10 and an information server 30. As shown in FIG. 3, the system 1 includes one or more indexing servers 10-1, 10-2, . . . , and 10-N (collectively referred to as indexing servers 10), a data node 20, and an information server 30, where N is an integer equal to or larger than 1.

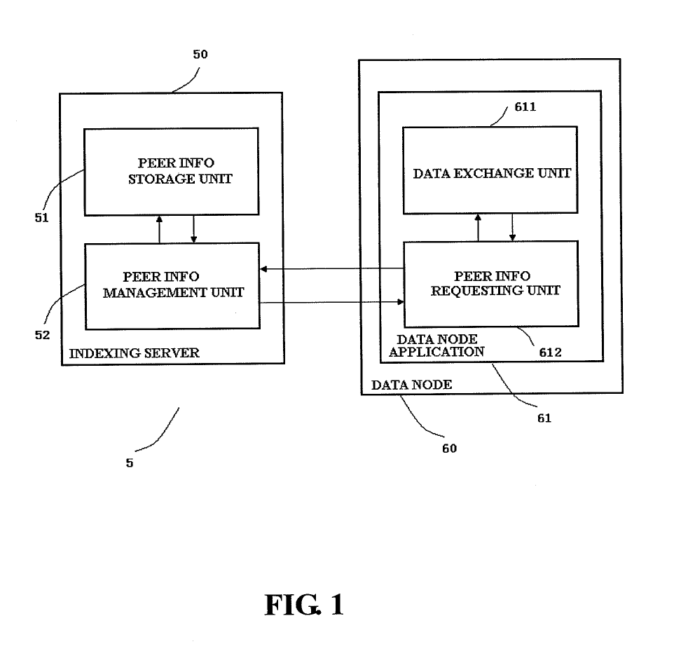

The indexing servers 10 are entities that store and index peer information and each may include a peer information storage unit and a peer information management unit as shown in FIG. 1. For simplicity, the internal configuration of indexing servers 10 is not shown in FIG. 3. The peer information storage unit of each of the indexing servers 10 stores information of all the data nodes on which the data node application units in the P2P system to which the indexing server belongs reside, including for example contact information, metadata of files owned, etc, and indexes the data nodes by files exchanged thereby (or, exchanged by the data node application units hosted by these data nodes). The peer information management unit is responsible for communicating with all the data node application units. It stores information in the peer information storage unit upon receipt of reports from data node application units, and provides peer lists as appropriate upon receipt of requests from data node application units.

The information server 30 is an entity that provides network information including distance, delay, traffic condition, and the like. The indexing servers and data node application units may query information on distance and network traffic between two data nodes through a service interface it provides. For simplicity, the internal configuration of the information server 30 is not shown in FIG. 3.

The data node 20 includes one or more data node application units 21-1, 21-2, . . . , and 21-N (collectively referred to as data node application units 21) belonging to one or more P2P systems respectively, and a list processing unit 22. The data node application unit 21-1, the indexing server 10-1, the information server 30, and one or more other data node application units that may reside on one or more other data nodes respectively (not shown) may constitute a 1^{st} P2P system; the data node application unit 21-2, the indexing server 10-2, the information server 30, and one or more other data node application units that may reside on one or more other data nodes respectively (not shown) may constitute a 2^{nd} P2P system; . . . . ; the data node application unit 21-N, the indexing server 10-N, the information server 30, and one or more other data node application units that may reside on one or more other data nodes respectively (not shown) may constitute an N^{th} P2P system; and so on. For example, BitTorrent application units residing on some data nodes, a BitTorrent indexing server and a shared information server may constitute a BitTorrent P2P system, while eMule application units residing on these data nodes, an eMule indexing server and the shared information server may constitute an eMule P2P system. Note that the case in which each of the N P2P systems includes an indexing server and all the P2P systems share one information server is illustrated here. However, as can be appreciated by those skilled in the art, the invention is not limited thereto. For example, each of the P2P systems may include a plurality of indexing servers. As another example, each of the P2P systems may have an information server of its own. In addition, different P2P systems may share one or more indexing servers.

Each of the data node application units 21 may include a data exchange unit and a peer information requesting unit. For example, the data node application unit 21-1 includes a data exchange unit 211-1 and a peer information requesting unit 212-1; the data node application unit 21-2 includes a data exchange unit 211-2 and a peer information requesting unit 212-2; . . . ; the data node application unit 21-N includes a data exchange unit 211-N and a peer information requesting unit 212-N; and so on.

In this embodiment, the list processing unit 22 includes a response message intercepting unit 221, a response message constructing unit 223, and one or more application message processing units 222-1, 222-2, . . . , and 222-N (collectively referred to as application message processing units 222). The application message processing units 222-1, 222-2, . . . , and 222-N are associated with the data node application units 21-1, 21-2, . . . , and 21-N respectively. That is, application message processing units 222-1, 222-2, . . . , and 222-N are in one-to-one correspondence with the data node application units 21-1, 21-2, . . . , and 21-N, for example. Each of the application message processing units 222 processes messages such as BitTorrent messages, eMule messages, and the like associated with a P2P system to which the corresponding one of the data node application units 21 belongs.

When a data node application unit, for example, data node application unit 21-1, in the data node 20 wants to exchange data with other data node application units in the P2P system to which it belongs, the peer information requesting unit 212-1 in the data node application unit 21-1 first issues a peer list request to the corresponding indexing server 10-1 for acquiring a list, which lists data node application units (i.e. peers) in the P2P system to which the data node application unit 21-1 belongs that can exchange data file with the data node application unit. Upon receipt of the peer list request, the peer information management unit in the indexing server 10-1 searches its peer information storage unit for data node application units available for exchanging the data, randomly selects from these data node application units a number of data node application units, and include the randomly selected data node application units as peers in the peer list to be returned. Due to the random selection, the peer list may include peers that reside on data nodes at a large distance from the data node 20 on which the data node application unit 21-1 resides, for example, coming from a different network domain. In other words, these peers are far from the data node application unit 21-1. For example, they come from different network domains than the data node application unit 21-1.

The list of peers thus randomly selected by each of the indexing servers 10 will be referred to as an original peer list herein. In an implementation, each of the indexing servers 10 includes the original peer list in a peer list response message and returns the response message to the data node that issued the peer list request.

As described above, the data node 20 of the invention includes a list processing unit 22. The list processing unit 22 may be added to the kernel space of the operating system of the data node 20 as a plug-in module. However, the invention is not limited thereto. As can be appreciated by those skilled in the art, the list processing unit 22 may be implemented in other software, hardware, firmware or the combination thereof.

The list processing unit 22 incepts the peer list response message, which is transmitted from one of the indexing servers 10 and ought to have been received by the data node application units 21. Specifically, the response message intercepting unit 221 in the list processing unit 22 may intercept the peer list response message. In an implementation, the response message intercepting unit 221 may intercept all the messages transmitted from the indexing servers by adding a hook in the operating system of the data node 20. In an implementation, the response message intercepting unit 221 may intercept these messages directly from the TCP/IP protocol stack of the operating system.

The response message intercepting unit 221 classifies the intercepted peer list response message to determine to which P2P system the peer list response message belongs, that is, with which of the data node application units 21-1, 21-2, . . . , and 21-N the message is associated, and delivers the peer list response message to the corresponding one of the application message processing units 222 according to the classification result.

In this example, since as described above the peer list request was issued by the data node application unit 21-1 and accordingly the peer list response message was returned by the indexing server 10-1, the response message intercepting unit 221 determines that the received peer list response message is directed to the data node application unit 21-1 based on the identification information contained in the message. Therefore, response message intercepting unit 221 delivers the peer list response message to the application message processing unit 222-1 associated with the data node application unit 21-1. For example, if the data node application unit 21-1 is a BitTorrent application, the response message intercepting unit 221 may recognize that the received message is a BitTorrent response message based on the identification information contained in the message and can thus deliver the message to the application message processing unit 222-1 associated with the BitTorrent application message.

Upon receipt of the peer list response message delivered from the response message intercepting unit 221, the application message processing unit 222-1 extracts the original peer list included therein. Then, the application message processing unit 222-1 issues a peer location request to the information server 30 for acquiring information regarding locations of data nodes on which the peers included in the original peer list reside with respect to the present data node 20.

In response to the peer location request from the application message processing unit 222-1, the information server 30 returns peer location information to the application message processing unit 222-1. In an example, the peer location information includes information regarding network distances (for example, P4P distances) between data nodes on which the peers listed in the original peer list reside and the data node 20.

The application message processing unit 222-1 performs a processing on the peers in the original peer list based on the peer location information returned from the information server 30. In an implementation, the processing includes ordering the peers in descending order of the network distances between the data nodes on which these peers reside and the data node 20. In an example, the processing further includes, after ordering the peers, removing from the list those peers residing on data nodes that are far away from the data node 20 if necessary. Thus, the peer list thus processed includes only peers on data nodes that are close to the data node 20, for example, peers on data nodes that are belong to the same network domain as the data node 20.

The application message processing unit 222-1 delivers the peer list thus processed to the response message constructing unit 223.

The response message constructing unit 223 collects the processed peer list delivered from the application message processing units, and provides a peer list response message including the processed peer list to a corresponding data node application unit. In this example, upon receipt of the processed peer list delivered from the application message processing unit 222-1, the response message constructing unit 223 provides it to the data node application unit 21-1 as a peer list response message for the corresponding P2P system. For example, if the data node application unit 21-1 is a BitTorrent application, then the response message constructing unit 223 will include the processed peer list in a BitTorrent response message to provide it to the data node application unit 21-1.

Upon receipt of the peer list response message including the processed peer list, the peer information requesting unit 212-1 in the data node application unit 21-1 extracts the peer list therefrom and provides it to the data exchange unit 211-1. The data exchange unit 211-1 can thus perform data exchange with the peers listed in the peer list.

Note that while explanation has been provided above with the data node application unit 21-1 and the associated application message processing unit 222-1 and indexing server 10-1 as example, the same solution is also applicable to other data node application units in the data node 20 and the associated application message processing units and indexing servers.

As can be seen, a data node application unit wishing to exchange data with peers acquires a list of peers located closely thereto rather than a list of randomly selected peers. Therefore, according to the invention, exiting P2P cross-domain traffic can be reduced without modifying existing indexing servers and data node application units, and messages associated with multiple different P2P systems can be processed at the same time by simply deploying in the data node one list processing unit provided as a plug-in for example.

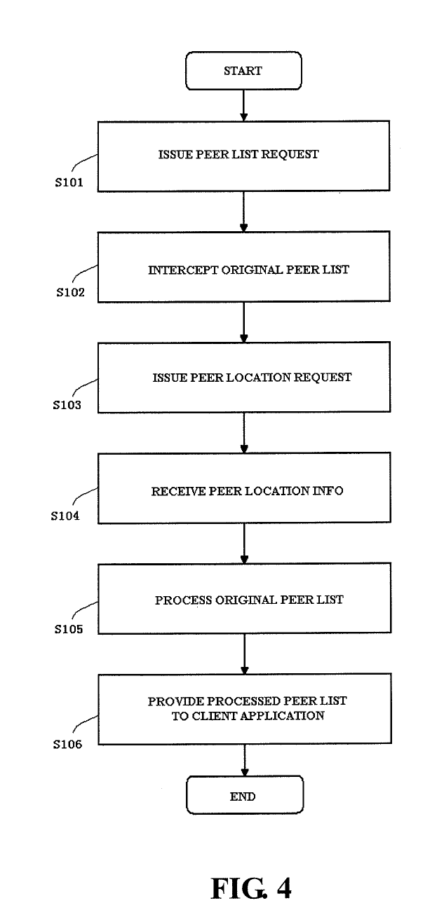

The method for acquiring a peer list by the data node 20 shown in FIG. 3 will be described below with reference to FIG. 4.

In step S101, the peer information requesting unit of one of the data node application units 21 issues a peer list request to a corresponding one of the indexing servers 10.

In step S102, the original peer list is intercepted. In this embodiment, this step may include the response message intercepting unit 221 intercepting a peer list response message transmitted from one of the indexing servers 10 in response to the peer list request, determining which one of the data node application units 21 is associated with the peer list response message, and then delivering the peer list response message to the corresponding one of the application message processing units 222. This step may also include one of the application message processing units 222 that receives the peer list response message delivered from the response message intercepting unit 221 extracting the original peer list included in the peer list response message to thereby intercept the original peer list.

In step S103, one of the application message processing units 222 issues a peer location request to the information server 30 to acquire information regarding locations of data nodes on which the peers included in the original peer list reside with respect to the present data node 20.

In step S104, the application message processing unit that issued the peer location request receives the peer location information returned from the information server 30.

In step S105, the application message processing unit performs a processing including for example ordering and removal of some peers on the peers in the original peer list based on the peer location information, and delivers the processed peer list to the response message constructing unit 223.

In step S106, the response message constructing unit 223, upon receipt of the processed peer list delivered from one of the application message processing units 222, provides a peer list response message including the processed peer list to the corresponding data node application unit. The process then ends.

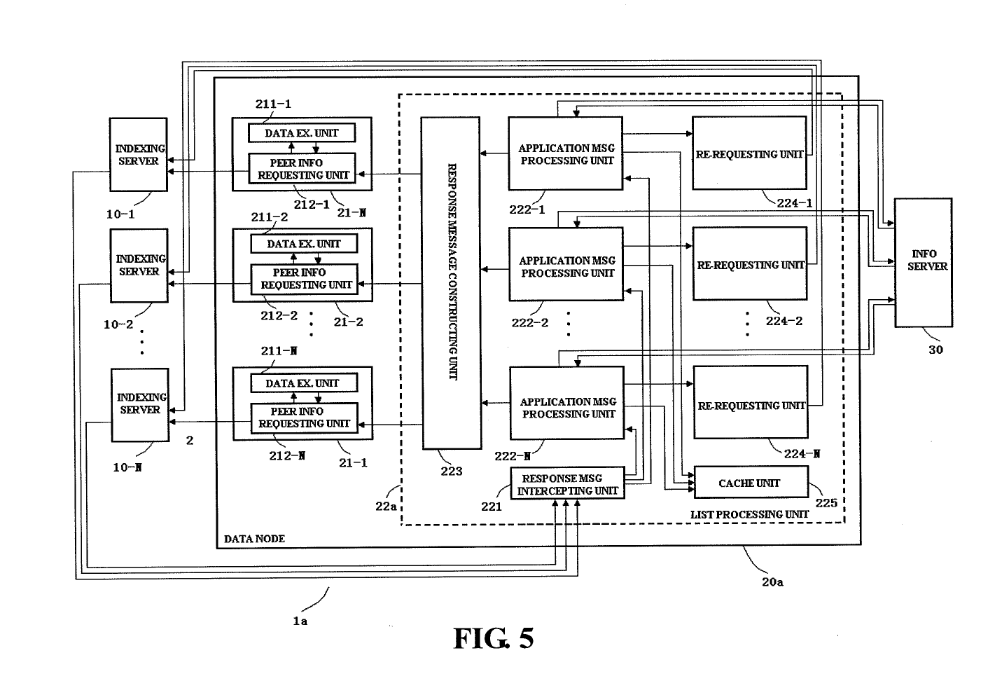

FIG. 5 shows a block diagram of a system 1a composed of an apparatus 20a serving as data node (referred to as data node 20a hereinafter) according to a second embodiment of the invention and one or more indexing servers 10 and an information server 30. In FIG. 5, the same reference numbers are used to indicate the same components as those in the first embodiment shown in FIG. 3, and detailed description of these components will be omitted.

As shown in FIG. 5, the data node 20a is different from the data node 20 shown in FIG. 3 in that, in addition to the response message intercepting unit 221, the application message processing units 222 and the response message constructing unit 223, the list processing unit 22a therein also includes one or more re-requesting units 224-1, 224-2, . . . , and 224-N (collectively referred as re-requesting units 224) that are in one-to-one correspondence with the data node application units 21-1, 21-2, . . . , and 21-N and hence in one-to-one correspondence with the application message processing units 222-1, 222-2, . . . , and 222-N, and cache unit 225.

The re-requesting units 224 can construct peer list requests for corresponding P2P systems to request more peer information from the corresponding indexing servers 10. The cache unit 225 may cache the processed peer list obtained in the process of acquiring the peer list. Note that in this embodiment, a case in which one cache unit 225 is shared by a plurality of application message processing units 222 is shown. In this case, each of the application message processing units 222 may access a corresponding area in the cache unit 225. Of course, other implementations may be conceived by those skilled in the art. For example, each of the application message processing units 222 may have its own cache unit.

Generally, in addition to ordering the original peer list by distance and removing some of the peers with large distance if necessary, the processing performed on the original peer list by the application message processing units of this embodiment also includes combining the peer list thus obtained with a peer list (if any) that has already been cached in the corresponding area in the cache unit 225. Then, the application message processing units determine whether the peers in the peer list thus processed are sufficient or not, for example, whether the number thereof reaches a threshold. If the number of peers is too small, the data node application unit cannot have enough data sources when performing data exchange, and the time for data download may be extended. To ensure a short download time, when determining that the number of peers is too small, the application message processing units of this embodiment will temporarily store the currently processed peer list in the corresponding area in the cache unit 225, and instruct the corresponding re-requesting unit to issue one or more additional peer list requests to the corresponding one of the indexing servers 10. Upon receipt of such additional peer list requests, the peer information management unit in the corresponding one of the indexing servers 10 will again search the peer information storage unit and randomly select therefrom peers that can exchange the data file desired by the corresponding data node application unit, to thereby provide one or more additional peer list response messages including original peer lists to the data node 20a. The application message processing units perform processings including ordering, removing and combining and the determination as mentioned above on the extracted one or more additional original peer lists, and repeats the re-requesting as necessary, until the number of peers is enough.

Explanation will be given by again taking application message processing unit 222-1 as example. Specifically, in an implementation, after extracting the original peer list in the peer list response message delivered from the response message intercepting unit 221, the application message processing unit 222-1 processes the original peer list.

The processing therein includes ordering the peers in the original peer list and removing peers at a large distance (for example, in a different network domain) if necessary, and combining the peer list including the remaining peers with the peer list (if any) in the corresponding area of cache unit 225.

In this case, the application message processing unit 222-1 will first check whether there is a previously cached peer list in the corresponding area of cache unit 225.

If the original peer list currently being processed is the original peer list returned by the indexing server 10-1 in response to the peer list request issued by the data node application unit, then the corresponding area of cache unit 225 shall be empty. In this case, the combination is not needed, and the peer list that has been ordered and from which some peers have been removed is the processed peer list.

On the other hand, if a peer list has already been cached in the corresponding area of cache unit 225, this indicates that the original peer list currently being processed is the original peer list returned by the indexing server 10-1 in response to an additional peer list request issued by a re-requesting unit. Then, the application message processing unit 222-1 combines the peer list that has been ordered and from which some peers may have been removed as described above with the peer list in the cache unit 225 to obtain the processed peer list.

In either case, the application message processing unit 222-1 will then determine whether the peers in the processed peer list are enough or not, for example, whether the number thereof reaches a predetermined threshold.

If the number is enough, the application message processing unit 222-1 will provides the processed peer list to the corresponding data node application unit 21-1 via the response message constructing unit 223. Before or after this, the application message processing unit 222-1 may empty the corresponding area in the cache unit 225.

On the other hand, if the peers are not enough, the application message processing unit 222-1 will cache the processed peer list in the corresponding area such that it is overwritten on any peer list originally cached in the corresponding area of cache unit 225, and instruct the corresponding re-requesting unit 224-1 to issue an additional peer list request to the indexing server 10-1. In response to this peer list request, the indexing server 10-1 will again return a peer list response message including a randomly selected peer list. The list processing unit 22a then repeats the process as described above, until the number of peers in the processed peer list is enough.

Of course, the above process is only an example. For example, the application message processing unit 222-2, after extracting the original peer list, may first combine the original peer list with the cached peer list (if any), and then order all the peers in the combined peer list by network distance and remove some peers with large distance if necessary, to derive the processed peer list. In this case, in addition to caching the peer list per se, information about the network distance between a data node hosting each peer and the present data node may also be cached. Other implementations may be conceived by those skilled in the art.

Similarly as with the first embodiment, while explanation has been provided above with the data node application unit 21-1 and the associated application message processing unit 222-1, re-requesting unit 224-1 and indexing server 10-1 as example, the same solution is also applicable to other data node application units in the data node 20 and the associated application message processing units, re-requesting units and indexing servers.

As described above, according to this embodiment, if the number of peers is not enough, the indexing server may be re-requested to return some randomly selected peers. Thus, the plentitude of peers may be ensured and a short download time may thus be ensured.

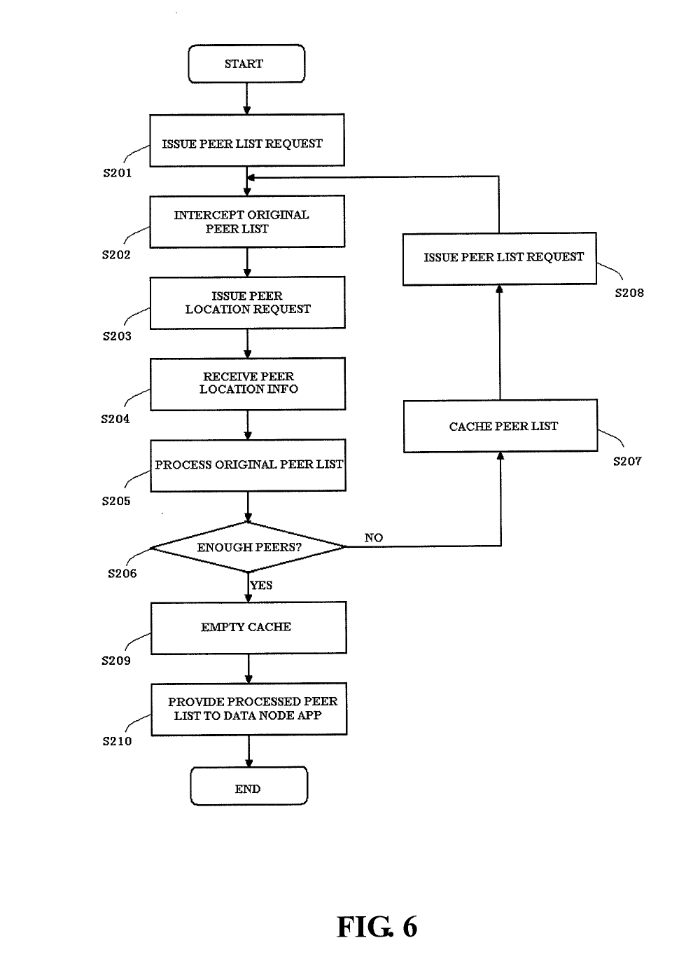

The method for acquiring a peer list by the data node 20a shown in FIG. 5 will be described below with reference to FIG. 6.

In step S201, the peer information requesting unit of one of the data node application units issues a peer list request to the corresponding one of the indexing servers 10.

In step S202, the original peer list is intercepted. In this embodiment, the original peer list may be an original peer list returned by one of the indexing servers 10 in response to the initial peer list request issued by the peer information requesting unit of a corresponding data node application unit, and may also be an original peer list returned by one of the indexing servers 10 in response to an additional peer list request issued by a corresponding re-requesting unit. In either case, the response message intercepting unit 221 may intercept the peer list response message including the original peer list, and deliver the peer list response message to the corresponding one of the application message processing units 222. Then, the corresponding one of the application message processing units 222 extracts the original peer list included in the peer list response message.

In step S203, the one of the application message processing units 222 which extracts the original peer list issues a peer location request to the information server 30 to acquire information regarding locations of the peers included in the original peer list with respect to the corresponding data node application unit (i.e., the locations of the data nodes on which these peer reside with respect to the present data node 20).

In step S204, the application message processing unit that issued the peer location request receives the peer location information returned from the information server 30.

In step S205, the application message processing unit performs a processing including ordering, removal, and combination with cached peer list (if any) on the original peer list based on the peer location information.

In step S206, the application message processing unit determines whether the peers in the processed peer list are enough or not, for example, whether the number thereof reaches a predetermined threshold.

If the peers are not enough (“NO” in step S206), the application message processing unit will cache the processed peer list in the corresponding area of the cache unit (step S207), and instruct the corresponding re-requesting unit to issue an additional peer list request to the indexing server (step S208). Then, the data node 20 repeats steps 5202 to 5206, until the number of peers in the processed peer list is enough.

On the other hand, if it is determined in step S206 that the peers are enough (“YES” in step S206), then the application message processing unit empties the corresponding area in the cache unit 225 in step S209 and provides the processed peer list to the corresponding data node application unit via the response message constructing unit in step S210. The process then ends.

While some specific embodiments of the invention have been described above, those skilled in the art can appreciate that various modifications, combinations and alterations may be made to the invention and the invention encompasses such modification, combinations and alterations as fall within the scope of the attached claims.

1. An apparatus that serves as a data node in peer-to-peer (P2P) data exchange, comprising:
a data node application unit that issues a peer list request and carries out P2P data exchange with peers; and
a list processing unit that intercepts an original peer list provided by an indexing server in response to the peer list request, issues a peer location request to an information server and receives peer location information provided by the information server in response to the peer location request, performs a processing on the original peer list based on the peer location information to derive a processed peer list, and provides the processed peer list to the data node application unit.

2. The apparatus according to claim 1, wherein
the list processing unit includes:
a message intercepting unit that intercepts a peer list response message including the original peer list that is provided by the indexing server in response to the peer list request, and delivers the intercepted peer list response message to an application message processing unit,
the application message processing unit that, upon receipt of the peer list response message delivered from the message intercepting unit, extracts the original peer list included in the peer list response message, issues the peer location request to the information server and receives the peer location information provided by the information server in response to the peer location request, performs the processing on the extracted original peer list based on the peer location information to derive the processed peer list, and provides the processed peer list to a message constructing unit, and
the message constructing unit that collects the processed peer list delivered from the application message processing unit and provides a peer list response message including the processed peer list to the data node application unit.

3. The apparatus according to claim 2, wherein
the list processing unit further includes:
a re-request unit operable to issue a peer list request, and
a cache unit operable to temporarily store a peer list; and
the application message processing unit determines whether the number of peers listed in the processed peer list has reached a threshold after performing the processing on the original peer list, and, in the event that the number has not reached the threshold, temporarily stores the processed peer list in the cache unit and instructs the re-request unit to issue a peer list request.

4. The apparatus according to claim 2, wherein
the data node application unit includes one or more data node application units;
the application message processing unit includes one or more application message processing units corresponding to the one or more data node application units;
the message intercepting unit intercepts a peer list response message including an original peer list provided in response to a peer list request associated with a particular data node application unit among the one or more data node application units, and delivers the intercepted peer list response message to an application message processing unit corresponding to the particular data node application unit, among the one or more application message processing units; and
the message constructing unit collects a processed peer list delivered from a particular application message processing unit among the one or more application message processing units, and provides a peer list response message including the processed peer list to a data node application unit corresponding to the particular application message processing unit, among the one or more data node application units.

5. The apparatus according to claim 3, wherein
the data node application unit includes one or more data node application units;
the application message processing unit includes one or more application message processing units corresponding to the one or more data node application units;
the re-request unit includes one or more re-request units corresponding to the one or more application message processing units;
the message intercepting unit intercepts a peer list response message including an original peer list provided in response to a peer list request associated with a particular data node application unit among the one or more data node application units, and delivers the intercepted peer list response message to an application message processing unit corresponding to the particular data node application unit, among the one or more application message processing units;
each of the one or more application message processing units, in the event that the number has not reached the threshold, stores the processed peer list in the cache unit and instructs a re-request unit corresponding to the self application message processing unit among the one or more re-request units to issue a peer list request; and
the message constructing unit collects a processed peer list delivered from a particular application message processing unit among the one or more application message processing units, and provides a peer list response message including the processed peer list to a data node application unit corresponding to the particular application message processing unit, among the one or more data node application units.

6. The apparatus according to claim 1, wherein
the peer location information includes information on network distances between data nodes on which peers listed in the original peer list reside and said data node; and
said processing includes ordering the peers listed in the original peer list in descending order of said network distances.

7. The apparatus according to claim 6, wherein said processing further includes removing peers residing on data nodes that are not within the same network domain as said data node, among the peers listed in the original peer list.

8. The apparatus according to claim 3, wherein
the peer location information includes information on network distances between data nodes on which peers listed in the original peer list reside and said data node; and
said processing includes ordering the peers listed in the original peer list in descending order of said network distances, removing peers residing on data nodes that are not within the same network domain as said data node among the peers listed in the original peer list, and combining a peer list including the remaining peers with a peer list that has been cached in the cache unit.

9. A method of acquiring peer information at a data node for peer-to-peer (P2P) data exchange, comprising the steps of:
issuing a peer list request to an indexing server;
intercepting an original peer list provided by the indexing server in response to the peer list request;
issuing a peer location request to an information server;
receiving peer location information provided by the information server in response to the peer location request;
performing a processing on the original peer list based on the peer location information to derive a processed peer list; and
providing the processed peer list to a data node application unit.

10. The method according to claim 9, further comprising:
determining whether the number of peers listed in the processed peer list has reached a threshold, and, in the event that the number has not reached the threshold, caching the processed peer list and issuing one or more additional peer list requests.

11. The method according to claim 9, wherein
the peer location information includes information on network distances between data nodes on which peers listed in the original peer list reside and said data node; and
said processing includes ordering the peers listed in the original peer list in descending order of said network distances.

12. The method according to claim 11, wherein said processing further includes removing peers residing on data nodes that are not within the same network domain as said data node, among the peers listed in the original peer list.

13. The method according to claim 10, wherein
the peer location information includes information on network distances between data nodes on which peers listed in the original peer list reside and said data node; and
said processing includes ordering the peers listed in the original peer list in descending order of said network distances, removing peers residing on data nodes that are not within the same network domain as said data node among the peers listed in the original peer list, and combining a peer list including the remaining peers with a cached peer list.

14. A system for providing and acquiring peer information in peer-to-peer (P2P) data exchange, comprising:
one or more indexing servers, each of which provides an original peer list in response to a peer list request;
an information server that provides peer location information in response to a peer location request; and
the apparatus of claim 1.
